(19) United States
(12) Patent Application Publication
(10) Pub. No.: US 2026/0059382 A1
(43) Pub. Date: Feb. 26, 2026

(54) DATA UNIT SEGMENTATION AND MULTIPLEXING

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US); Sitaramanjaneyulu KANAMARLAPUDI, San Diego, CA (US)

(21) Appl. No.: 18/815,586

(22) Filed: Aug. 26, 2024

(51) Int. Cl. H04W 28/06; H04L 1/00; H04W 28/22

(52) U.S. Cl. CPC H04W 28/06; H04L 1/0008; H04W 28/22

(57) ABSTRACT

Methods, systems, and devices for wireless communications are described. A user equipment (UE) receives a control message indicating a configuration comprising a segmentation rule for data unit segmentation. The UE transmits a first packet including one or more data units in accordance with the configuration, where a second data unit is available for transmission in the first packet prior to transmission of the first packet and transmission of the second data unit is delayed to avoid segmentation of the second data unit in the first packet. The UE receives, subsequent to transmission of the first packet, a grant indicating a resource allocation that is at least a size of the second data unit. The UE transmits a second packet including. the second data unit based on the grant.

### FIELD OF TECHNOLOGY

The following relates to wireless communications, including data unit segmentation and multiplexing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE communicates with a network entity. The network entity may communicate one or more grants indicating resources for the UE to transmit one or more data units in one or more packets (e.g., packed data units) in the one or more resources. The network entity may also configure the UE to segment a data unit based on a segmentation rule for data unit segmentation. For example, if a data unit does not fit in a packet (e.g., when the size of the data unit is greater than the can be transmitted in the resource), then the UE may segment the data unit into multiple segments or data units so that at least one segment is transmitted in the packet and at least another segment is transmitted in a subsequent packet. However, conventional segmentation rules are deficient.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a control message indicating a configuration including a segmentation rule for data unit segmentation, transmitting a first packet including one or more data units in accordance with the configuration, where a second data unit is available for transmission in the first packet prior to transmission of the first packet and transmission of the second data unit is delayed to avoid segmentation of the second data unit in the first packet, receiving, subsequent to transmission of the first packet, a grant indicating a resource allocation that is at least a size of the second data unit, and transmitting a second packet including the second data unit based on the grant.

A UE for wireless communications is described. The UE may include one or more memories storing processor executable code, and one or more processors coupled with the one or more memories. The one or more processors may individually or collectively be operable to execute the code to cause the UE to receive a control message indicating a configuration including a segmentation rule for data unit segmentation, transmit a first packet including one or more data units in accordance with the configuration, where a second data unit is available for transmission in the first packet prior to transmission of the first packet and transmission of the second data unit is delayed to avoid segmentation of the second data unit in the first packet, receive, subsequent to transmission of the first packet, a grant indicating a resource allocation that is at least a size of the second data unit, and transmit a second packet including the second data unit based on the grant.

Another UE for wireless communications is described. The UE may include means for receiving a control message indicating a configuration including a segmentation rule for data unit segmentation, means for transmitting a first packet including one or more data units in accordance with the configuration, where a second data unit is available for transmission in the first packet prior to transmission of the first packet and transmission of the second data unit is delayed to avoid segmentation of the second data unit in the first packet, means for receiving, subsequent to transmission of the first packet, a grant indicating a resource allocation that is at least a size of the second data unit, and means for transmitting a second packet including the second data unit based on the grant.

A non-transitory computer-readable medium storing code for wireless communications is described. The code may include instructions executable by one or more processors to receive a control message indicating a configuration including a segmentation rule for data unit segmentation, transmit a first packet including one or more data units in accordance with the configuration, where a second data unit is available for transmission in the first packet prior to transmission of the first packet and transmission of the second data unit is delayed to avoid segmentation of the second data unit in the first packet, receive, subsequent to transmission of the first packet, a grant indicating a resource allocation that is at least a size of the second data unit, and transmit a second packet including the second data unit based on the grant.

Some examples of the method, UEs, and non-transitory computer-readable medium described herein may further include operations, features, means, or instructions for adjusting the segmentation rule based on a predictive model that predicts a grant, data traffic, or both, where transmission of the second data unit may be delayed by the predictive model in accordance with the adjusted segmentation rule to avoid segmentation of the second data unit in the first packet.

In some examples of the method, UEs, and non-transitory computer-readable medium described herein, segmentation of the second data unit may be avoided based on the UE being associated with a data rate that may be greater than a data rate threshold.

In some examples of the method, UEs, and non-transitory computer-readable medium described herein, segmentation of the second data unit may be avoided based on a waiting time associated with the second data unit being less than a maximum waiting time threshold.

Some examples of the method, UEs, and non-transitory computer-readable medium described herein may further include operations, features, means, or instructions for adding one or more padding bits to the first packet to fill one or more remaining bits of the first packet to avoid segmentation of the second data unit in accordance with the segmentation rule.

In some examples of the method, UEs, and non-transitory computer-readable medium described herein, the one or more padding bits includes a medium access control (MAC) control element (CE), uplink control information, or a radio link control message to indicate a minimum grant size associated with the second data unit, a preferred cell to receive a grant associated with the second data unit, an expiration time associated with the second data unit, a rate threshold second data unit, or any combination thereof.

Some examples of the method, UEs, and non-transitory computer-readable medium described herein may further include operations, features, means, or instructions for adding at least one data unit to the first packet to fill one or more remaining bits of the first packet to avoid segmentation of the second data unit in accordance with the segmentation rule, where the at least one data unit may have lower priority than the second data unit.

Some examples of the method, UEs, and non-transitory computer-readable medium described herein may further include operations, features, means, or instructions for storing segmentation-related data occurring over a time period and transmit, to a server or a network entity, the segmentation-related data to update a predictive model used to delay the transmission of the second data unit.

Some examples of the method, UEs, and non-transitory computer-readable medium described herein may further include operations, features, means, or instructions for receiving a second control message indicating an update to the segmentation rule.

In some examples of the method, UEs, and non-transitory computer-readable medium described herein, the second control message indicates a key performance indicator, a fallback rule associated with the key performance indicator, a range or a rule associated with a configuration for a behavior, a range or a rule associated with at least one key performance indicator, a maximum skipped grant size, a maximum waiting time, a minimum data rate, a segmentation metric, a latency metric, or any combination thereof.

Some examples of the method, UEs, and non-transitory computer-readable medium described herein may further include operations, features, means, or instructions for receiving a third control message indicating to pause or stop segmentation based on a violation of a key performance indicator.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports data unit segmentation and multiplexing in accordance with one or more aspects of the present disclosure.

FIG. 2 shows an example of a wireless communications system that supports data unit segmentation and multiplexing in accordance with one or more aspects of the present disclosure.

FIG. 3 shows an example of reducing data unit segmentation that supports data unit segmentation and multiplexing in accordance with one or more aspects of the present disclosure.

FIG. 4 shows an example of reducing data unit segmentation that supports data unit segmentation and multiplexing in accordance with one or more aspects of the present disclosure.

FIG. 5 shows an example of a segmentation-related signaling that supports data unit segmentation and multiplexing in accordance with one or more aspects of the present disclosure.

FIG. 6 shows an example of a process flow that supports data unit segmentation and multiplexing in accordance with one or more aspects of the present disclosure.

FIGS. 7 and 8 show block diagrams of devices that support data unit segmentation and multiplexing in accordance with one or more aspects of the present disclosure.

FIG. 9 shows a block diagram of a communications manager that supports data unit segmentation and multiplexing in accordance with one or more aspects of the present disclosure.

FIG. 10 shows a diagram of a system including a device that supports data unit segmentation and multiplexing in accordance with one or more aspects of the present disclosure.

FIGS. 11 through 13 show flowcharts illustrating methods that support data unit segmentation and multiplexing in accordance with one or more aspects of the present disclosure.

### DETAILED DESCRIPTION

In some wireless communications systems, a UE communicates with a network entity. The network entity may communicate one or more grants over a period for the UE to transmit one or more data units (e.g., packed data units). The network entity may also configure the UE to segment a data unit based on a segmentation rule for data unit segmentation. For example, if a data unit does not fit in a grant (e.g., when the size of the data unit is greater than the grant), then the UE may segment the data unit into multiple segments or data units so that at least one segment is transmitted in the grant and at least another segment is transmitted in a subsequent grant. However, conventional segmentation rules may cause issues, such as complicated layer two processing, segmentation of a status packet data unit that renders the segmented status packet data unit useless, segmentation introducing latency delay for involving reassembly, or any combination thereof.

The techniques herein discuss a wireless device, such as UE, that intelligently segments data units, including avoiding segmentation of data units in some situations, to reduce or avoid issues with conventional segmentation rules. In some cases, to avoid segmentation of a data unit, the UE 115 may fill a packet with a combination of low priority data units and high priority data units. For example, rather than segmenting a high priority data unit to fit a portion of the high priority data unit (e.g., a data unit segment) in the packet, the UE 115 may fill the packet with one or more low priority data units instead, to delay sending the high priority data unit until receipt of a grant allocating a resource that is sufficiently large for transmission of a subsequent packet that includes the entirety of the high priority data unit. In some examples, additionally, or alternatively, the UE 115 may pad a packet (e.g., with padding bits, medium access control (MAC) control elements (CE) (MAC-CEs), etc.) instead of segmenting a high priority packet, to delay sending the high priority data unit until receipt of a grant allocating a resource that is sufficiently large for transmission of a packet that includes the entirety of the high priority data unit. In some examples, the UE 115 may predict, based on a predictive model, a grant allocation and may avoid segmentation accordingly. For example, the UE 115 may predict upcoming grants and make decisions to avoid segmentation accordingly due to an expected upcoming grant. In other scenarios, the UE 115 may transmit a request to the network entity 105 for a grant that allocates a resource that is sufficiently large for transmission of a packet that includes the entirety of the high priority data unit, to avoid segmentation of that high priority data unit.

Aspects of the disclosure are initially described in the context of wireless communications systems. Aspects of the disclosure are further illustrated by and described with reference to apparatus diagrams, system diagrams, and flowcharts that relate to data unit segmentation and multiplexing.

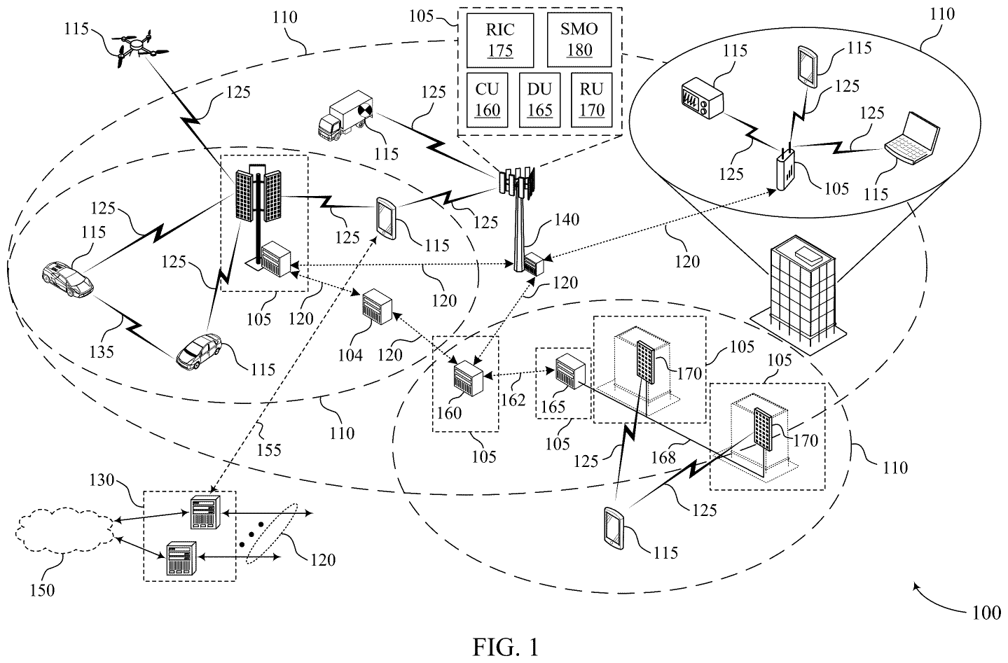

FIG. 1 shows an example of a wireless communications system 100 that supports data unit segmentation and multiplexing in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an

RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, in the wireless communications systems 200, the network entity 105 may communicate one or more grants indicating resources (e.g., time and/or frequency resources) for the UE 115 to transmit one or more data units in one or more packets (e.g., packed data units) over the one or more resources. The network entity 105 may also configure the UE 115 to segment a data unit based on a segmentation rule for data unit segmentation. For example, if a data unit does not fit in a packet (e.g., when the size of the data unit is greater than the can be transmitted in the resource), then the UE 115 may segment the data unit into multiple segments or data units so that at least one segment is transmitted in the packet and at least another segment is transmitted in a subsequent packet. However, conventional segmentation rules may cause issues, such as complicated layer two processing, segmentation of a status packet data unit that renders the segmented status packet data unit useless, segmentation introducing latency delay for involving reassembly, or any combination thereof.

The techniques herein discuss a wireless device, such as UE, that intelligently segments data units, including avoiding segmentation of data units in some situations, to reduce or avoid issues with conventional segmentation rules. In some cases, to avoid segmentation of a data unit, the UE 115 may fill a packet with a combination of low priority data units and high priority data units. For example, rather than segmenting a high priority data unit to fit a portion of the high priority data unit (e.g., a data unit segment) in the packet, the UE 115 may fill the packet with one or more low priority data units instead, to delay sending the high priority data unit until receipt of a grant allocating a resource that is sufficiently large for transmission of a subsequent packet that includes the entirety of the high priority data unit. In some examples, additionally, or alternatively, the UE 115 may pad a packet (e.g., with padding bits, medium access control (MAC) control elements (CE) (MAC-CEs), etc.) instead of segmenting a high priority packet, to delay sending the high priority data unit until receipt of a grant allocating a resource that is sufficiently large for transmission of a packet that includes the entirety of the high priority data unit. In some examples, the UE 115 may predict, based on a predictive model, a grant allocation and may avoid segmentation accordingly. For example, the UE 115 may predict upcoming grants and make decisions to avoid segmentation accordingly due to an expected upcoming grant. In other scenarios, the UE 115 may transmit a request to the network entity 105 for a grant that allocates a resource that is sufficiently large for transmission of a packet that includes the entirety of the high priority data unit, to avoid segmentation of that high priority data unit.

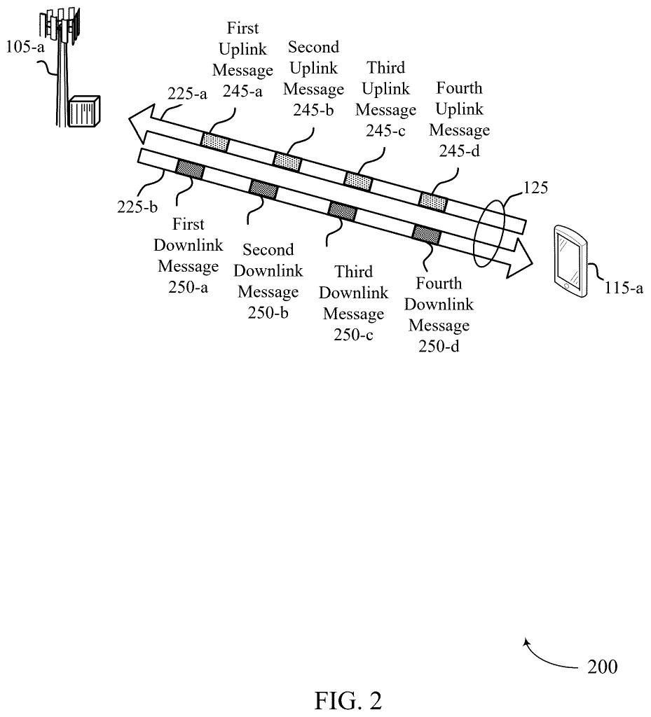

FIG. 2 shows an example of a wireless communications system 200 that supports data unit segmentation and multiplexing in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1.

A UE 115-a may obtain data units that include data to be transmitted to a network entity 105-a. The network entity 105-a may transmit one or more grants to the UE 115-a to allocate one or more resources (e.g., time and frequency resource) to the UE 115-a for transmission of one or more packets. The UE 115-a may generate a packet by filling a packet payload with one or more data units. A size of the payload of the packet may be based on a size of a resource allocated by a grant for transmission of the packet. In some cases, a size of a data unit may be larger than a remaining size of the packet payload.

A data unit may be segmented when a packet size or remaining packet size (e.g., based on a grant) of the packet payload is less than a size of a data unit (e.g., an RLC service data unit (SDU) along with the header). Segmenting the data unit may include adding an appropriate header for the packet data unit segments. For example, when a grant size or a remaining grant size is less than a size of a packet data unit, a packet may be generated by segmenting the data unit and adding a header, where the packet includes a data unit segment and the added header. For example, a data unit may be an RLC SDU that includes an RLC SDU header, and a packet may be an RLC PDU that is built by segmenting the SDU and adding an RLC PDU header. In some examples each of the data unit segments may include a segment sequence number, a segment offset, an indication of how to organize multiple segments, or any combination thereof. In some examples, status reports indicating acknowledgement (ACK) or negative acknowledgement (NACK) for signals received at the UE 115-a, may be indicated in individual segments.

In some examples, the UE 115-a may perform resegmentation of the segments of the data unit. For example, in RLC acknowledgement mode (AM), resegmentation may occur for retransmission of the data unit based on receiving a grant that includes a new grant size. A receive of the retransmission may discard duplicated bytes of the data unit.

In some examples, the segmentation may occur with respect to a MAC entity (e.g., the UE 115-a) transmitting MAC data units. The MAC entity transmitting the data units may prioritize a logical channel (LCH) according to a leaky bucket prioritization scheme in accordance with Table 1.

TABLE 1

| Leaky bucket parameters | Procedure |
|---|---|
| bucketSizeDuration (BSD) | Increment Bⱼ by PBR × T |
| PrioritizedBitRate (PBR) | Compare Bⱼ against bucket size: |
| Priority | PBR × BSD |

For example, if the MAC entity is requested to simultaneously transmit multiple MAC data units (e.g., MAC packet data units (PDUs)) or if the MAC entity receives multiple uplink grants within one or more coinciding physical downlink control channels (PDCCH) occasions (e.g., on different serving cells), the UE 115-a may determine the sequence of processing the multiple received uplink grants.

In some examples, the UE 115-a may be configured to follow one or more rules during scheduling procedures associated with Table 1. The one or more rules may indicate that the UE 115-a may not segment a data unit (e.g., an RLC SDU) (or a partially transmitted data unit or retransmitted data unit) if the size of the entire data unit (or the partially transmitted data unit or the retransmitted data unit) fits into the remaining resources in a grant for the associated MAC entity. The one or more rules may indicate that if the UE 115-a segments a data unit (e.g., RLC SDU) from the logical channel, the UE 115-a may increase the size of the segment to fill (e.g., as much as possible) the packet for the grant of the associated MAC entity. The one or more rules may indicate that the UE 115-a may increase or maximize the transmission of data.

In some examples, the one or more rules may indicate that if the MAC entity is given an uplink grant size that is equal to or larger than a threshold quantity of bytes while having data available and allowed for transmission, the MAC entity may not transmit only padding buffer status reporting (BSR) and/or padding bits or bytes. In some examples, the threshold quantity of bytes may be 8 bytes, for example, when extended logical channel identifier (eLCID) is not used, or 10 bytes, for example, when eLCID is used, while having data available and allowed for transmission, the MAC entity may not transmit only padding BSR and/or padding bits or bytes. As an example, if the UE 115-a (e.g., MAC entity) receives an uplink grant size that is at least 8 bytes while having pending data units available for transmission, then the UE 115-a may not transmit only padding in a packet over the uplink resources.

In some examples, conventional segmentation rules may have a number of problems. Conventional segmentation rules may cause the UE 115-a to arbitrarily segment the data unit, for example, into arbitrarily small transport blocks (TB). The segmentation rule resulting in arbitrarily sized segments may include a rule to maximize the transmission of data. In some examples, the rule may indicate that if the UE 115-a is given an uplink grant size that is equal to or greater than a threshold size (e.g., 8 bytes or 10 bytes) while having data available and allowed for transmission, the UE 115-a may not transmit padding BSR alone and/or padding alone.

Such rules applied to a header segmentation, such as a PDCP header segmentation, may result in inefficient layer two (L2) processing due to the logic of associated with the PDU structure. For example, implementation of such rules may result in the UE 115-a implementing additional handling procedures and/or QCT.

Such rules applied to a status data unit segmentation, such as a RLC Status PDU segmentation, may result in inefficient segmentation or resegmentation. For example, segmenting a status data unit may not be allowed or may not be processed, and thus, the UE 115-a may rebuild the status data unit to be transmitted in a subsequent grant. Moreover, in some examples, the status packet data unit may have a greater priority in data, resulting in head-of-line (HOL) blocking.

Moreover, processing segmentation and/or resegmentation may result in processing latencies or delays. For example segmentation and/or resegmentation may result in latencies caused by the multiple segmenting procedures or the UE 115-a having to reassemble segments of the segmented data unit. Such latencies may also impact a UE 115-a located at a cell edge by reducing throughput and increasing delays.

In the wireless communications system 200, the network entity 105-a may communicate with the UE 115-a using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225-a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125). In some examples, the downlink messages 250 may be part of control signaling transmitted from the network entity 105-a. In some examples, the network entity 105-a may transmit the downlink messages 250 over beamformed beams 260 based on a beam sweeping pattern.

In some examples, the UE 115-a may transmit, to the network entity 105-a, over the first channel 225-a, a first uplink message 245-a. The uplink message may indicate a capability of the UE 115-a to perform segmentation and resegmentation. Accordingly, the UE 115-a may receive, from the network entity 105-a over the second channel 225-b, a first downlink message 250-a indicating a configuration including a segmentation rule to be applied to data units. The UE 115-a may also receive a second downlink message 250-b indicating a first grant indicating a resource allocation in a first time (e.g., in a first slot) and that is associated with a first size.

The UE 115-a may have a data unit available and allowed for transmission in a packet. However, the data unit size may exceed the size of an available resource associated with the first grant. The UE 115-a may decide not to segment the data unit to avoid one or more of the issues with data unit segmentation described herein. In other words, although the data unit is available and could be segmented for transmission of a data unit segment, the UE 115-a may delay transmission of the data unit until a grant is received that allocates a resource of a sufficient size for transmission of a packet that includes an entirety of the data unit. As such, instead of transmitting the data unit that does not entirety fit in a resources allocated for packet transmission, the UE 115-a may transmit, in the resources associated with the first grant, a second uplink message 245-b that includes a packet. The packet may not include the data unit since the UE 115-a may not segment the data unit even though the segmentation rule may indicate to segment the packet unit. The UE 115-a may avoid segmentation of the data unit using the techniques discussed herein. Storing segmentation-related data and updating a predictive model, the UE 115-a may determine future grants, as well as recommend a grant size to the network entity 105-a based on the packet size (e.g., and a prediction that upcoming grants are not large enough). The predictive model may be, in some examples, an artificial intelligence (AI)-based model. The UE 115-a may transmit a third uplink message 245-c indicating the recommended grant size to transmit the data unit in a subsequent packet.

In some examples, the UE 115-a may receive a third downlink message 250-c indicating a second grant, for example, based on the recommendation from the UE 115-a. The second grant may allocate enough resources for the UE 115-a to transmit the data unit in a packet without segmentation. Accordingly, the UE 115-a may transmit a fourth uplink message 245-d that includes a second packet, which includes the data unit.

In some examples, the UE 115-a may receive a fourth downlink message 250-d indicating for the UE 115-a to stop or pause segmentation. For example, the segmentation may result in key performance indicators (KPIs) being below a performance threshold due to the segmentation.

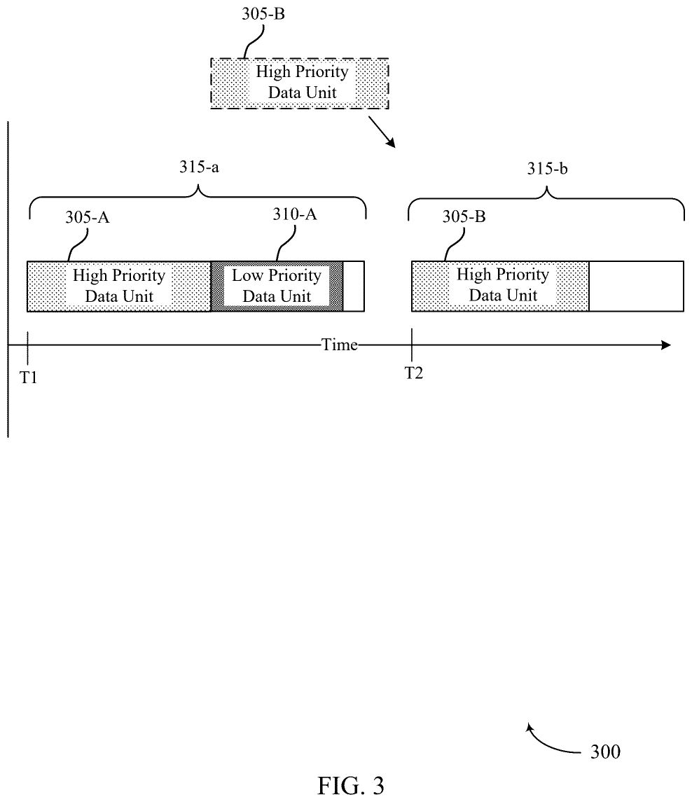

FIG. 3 shows an example of a first data unit segmentation scheme 300 that supports data unit segmentation and multiplexing in accordance with one or more aspects of the present disclosure. The first data unit segmentation scheme 300 may be associated with transmission of multiple high priority data units 305 and/or one or more low priority data units 310 in multiple packet 315 via resources in multiple grants.

The UE 115 may participate in a grant prediction where the UE 115 may predict a statistical pattern of grant allocation of resources or a pattern of channel acquisition (e.g., NR unlicensed (NR-U)) in during a time. For example, based on the statistical pattern, the UE 115 may avoid segmentation of a data unit to be transmitted in a packet 315 and rather, the UE 115 may transmit the data unit without segmenting and in a subsequent grant (based on the prediction).

In this example, the UE 115 may receive a grant, from a network entity 105, of a resource beginning at time TI for transmission of a packet. In response to the grant, the UE 115 may generate and transmit a first packet 315-a at the resource beginning at time T1. The first packet 315-a may include a first high priority data unit 305-a. Based on a segmentation rule indicated by the network entity 105, the UE 115 may be configured to segment a second high priority data unit 305-b that is available for transmission in the first packet 315-a, such as to be transmitted in the first packet 315-a along with the first high priority data unit 305-a. However, as shown, an entirety of the second high priority data unit 305-b may not fit in the first packet 315-a (e.g., not enough resources) based on the size of the packet (e.g., based on a size of the grant) and/or other data also being transmitted in the first packet 315-a, such as the first high priority data unit 305-a.

To avoid segmentation of the second high priority data unit 305-b, the UE 115 may instead fill the first packet 315-a with one or more low priority data units 310 instead of the second high priority data unit 305-b. In some examples, the UE 115 may avoid segmentation based on the content of the data unit, such as one or more high priority data units. For example, segmenting of the second high priority data unit 305-b may result in the issues with conventional segmentation techniques described herein.

At some other time, the UE 115 may receive a second grant, from a network entity 105, of a resource beginning at time T2 for transmission of a packet. The second grant of the resource beginning at time T2 may be at least the size of the second high priority data unit 305-b, as shown, to enable transmission of an entirety of the second high priority data unit 305-b in a same packet. The UE 115 may subsequently transmit a second packet 315-b that includes the entirety of the second high priority data unit 305-b. Avoiding segmentation of the second high priority data unit 305-b for inclusion in the first packet 315-a and instead delaying transmission of the second high priority data unit 305-b for inclusion in the second packet 315-b may avoid the issues with conventional segmentation techniques described herein.

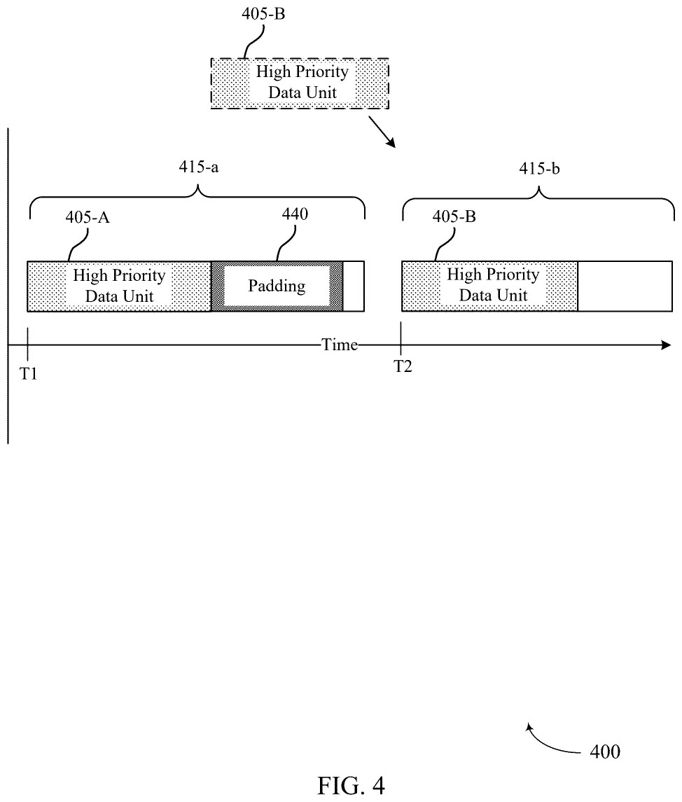

FIG. 4 shows an example of a second data unit segmentation scheme 400 that supports data unit segmentation and multiplexing in accordance with one or more aspects of the present disclosure.

The second data unit segmentation scheme 400 may include one or more high priority data units 405 and/or one or more low priority data units 410 that are transmitted in multiples packet 415 via resources indicated in multiple grants.

In this example, the UE 115 may receive a grant, from a network entity 105, of a resource beginning at time TI for transmission of a packet. In response to the grant, the UE 115 may generate and transmit a first packet 415-a at the resource beginning at time T1. The first packet 415-a may include a first high priority data unit 405-a. Based on a segmentation rule indicated by the network entity 105, the UE 115 may be configured to segment a second high priority data unit 405-b that is available for transmission in the first packet 415-a, such as to be transmitted in the first packet 415-a along with the first high priority data unit 405-a. However, as shown, an entirety of the second high priority data unit 405-b may not fit in the first packet 415-a (e.g., not enough resources) based on the size of the packet (e.g., based on a size of the grant) and/or other data also being transmitted in the first packet 415-a, such as the first high priority data unit 405-a.

To avoid segmentation of the second high priority data unit 305-b, the UE 115 may instead may pad the packet 415-a with one or more padding bits in the remaining portion of the first packet 415-a. Accordingly, here, the first packet 415-a includes a combination of the first high priority data unit 415-a and padding bits 440 (e.g., rather than the a combination the first high priority 415-a and a segment of the second high priority data unit 405-b.

At some other time, the UE 115 may receive a second grant, from a network entity 105, of a resource beginning at time T2 for transmission of a packet. The second grant of the resource beginning at time T2 may be at least the size of the second high priority data unit 405-b, as shown, to enable transmission of an entirety of the second high priority data unit 405-b in a same packet. The UE 115 may subsequently transmit a second packet 415-b that includes the entirety of the second high priority data unit 405-b. Avoiding segmentation of the second high priority data unit 405-b for inclusion in the first packet 315-a and instead delaying transmission of the second high priority data unit 405-b for inclusion in the second packet 415-b may avoid the issues with conventional segmentation techniques described herein.

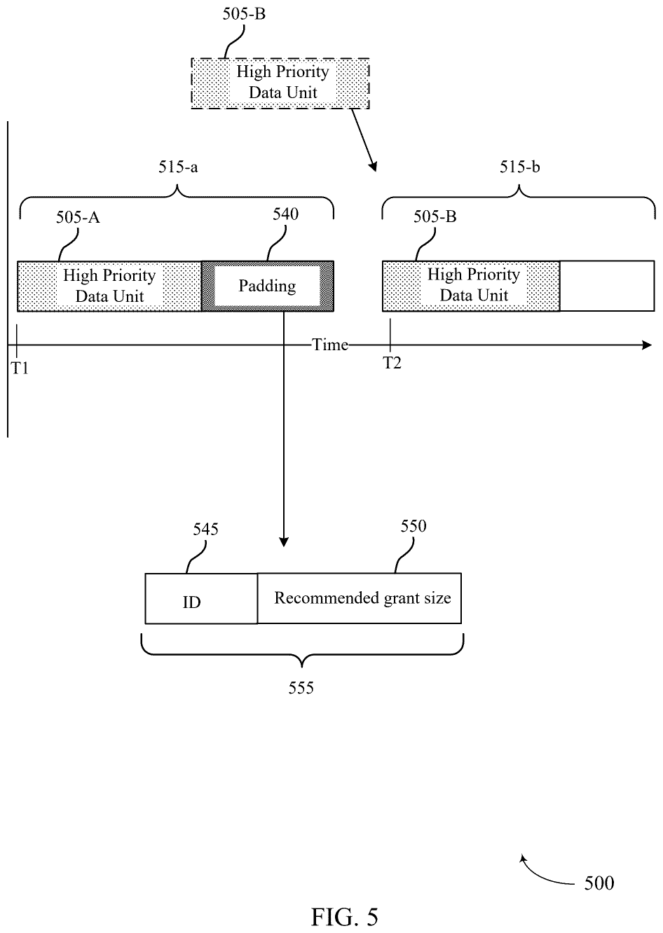

FIG. 5 shows an example of a segmentation-related signaling 500 that supports data unit segmentation and multiplexing in accordance with one or more aspects of the present disclosure. Padding bits of a packet may include segmentation-related control signaling 555 that is communicated for segmented-related data, such as for segmentation, multiplexing, reducing data unit segmentation as shown an discussed herein, and also with reference to FIGS. 3 and 4.

In some examples, the UE 115 may skip transmitting a data unit in a packet that involves segmentation, as discussed herein and also with reference to FIGS. 3 and 4. In such examples, skipping the segmentation may not involve signaling from the UE 115 to the network entity 105, and thus may be performed autonomously by the 115. However, if padding is used for the skipping, as discussed herein and in FIGS. 4-5, then the padding may include control information (e.g., used for filling and/or multiplexing data in a packet) that may be used to indicate that the UE 115 has a data unit of a certain size that is waiting for transmission and for which segmentation has been skipped. For example, the padding bits may include segmentation-related control signaling 555, such as a control message. The control message may be a MAC-CE, an RLC control PDU, an uplink control information (UCI), or the like, indicating that a data unit 505-b (e.g., RLC SDU) having a certain size is waiting for transmission. The padding bits 540 may also indicate that, for the packet 515-a with the padding bits 540, that multiplexing is padded since segmentation was to be used for the packet (e.g., that does not include the data unit 505-b). As an example, the new MAC-CE signaling may include an identifier (ID) 545, which may indicate a logical channel ID (LCID), and an indication of a recommended grant size 550 for the data unit 505-b that is available and is awaiting transmission. The ID 545 may identify the data unit 505-b waiting for transmission (e.g., the RLC SDU). The indication of a recommended grant size 550 may include a recommendation of a requested grant size (e.g., minimum requested grant size) for a resource for transmission of packet that is sufficiently large to include an entirety of the data unit waiting to be transmitted. The UE 115 transmitting the segmentation-related signaling 555 may reduce latency otherwise associated with the UE 115 waiting for a grant that is sufficiently large to transport an entirety of the data unit.

In an example, a UE 115 may transmit, beginning at time T1, a first packet 515-a that includes a first high priority data unit 505-a and padding bits 540. The padding bits 540 may include a control message that includes an identifier 545 (e.g., logical channel identifier) associated with a data unit 505-b and a recommended grant size indicating a requested size of a grant for transmission of an entirety of a second high priority data unit 505-b that is awaiting transmission. A network entity 105 may receive the packet 515-a that includes a high priority data unit 505-a and the padding bits 540. The network entity 105 may process the padding bits 540 to identify the requested grant size and may subsequently transmit a second grant to the UE 115, where a size of a resource indicated by the second grant is sufficiently large to enable transmission of an entirety of the second high priority data unit 505-b in a same packet. The UE 115 may receive the second grant, from a network entity 105, of a resource beginning at time T2 for transmission of a packet. The second grant of the resource beginning at time T2 may be at least the size of the second high priority data unit 505-b, as shown, to enable transmission of an entirety of the second high priority data unit 505-b in a same packet. The UE 115 may subsequently transmit a second packet 515-b that includes the entirety of the second high priority data unit 505-b. Avoiding segmentation of the second high priority data unit 305-b for inclusion in the first packet 315-a and instead delaying transmission of the second high priority data unit 305-b for inclusion in the second packet 315-b may avoid the issues with conventional segmentation techniques described herein.

In some examples, the segmentation-related control signaling 555 in the padding bits 540 may be a MAC-CE, an RLC control PDU, UCI, etc., or any combination thereof. The segmentation-related control signaling 555, for example, that is used for padding, may include multiple fields. The fields may indicate, for example, a defined (e.g., minimum) grant size requested for the data unit, one or more preferred cells from which to receive the grant, a time to expiration of the data unit, an indication of whether the UE 115 is using a rate threshold for segmentation along with the rate threshold, or any combination thereof. In some examples, the segmentation-related control signaling 555 may be a new MAC-CE (e.g., or RLC control PDU or UCI) signal or an optional addition to a buffer status report (BRS), delay status report (DSR), or both, when the UE opts not to segment the data unit.

In some examples, the UE 115 may adjust current multiplexing rules (e.g., RLC and MAC multiplexing rules) to avoid excessive segmentation. Such adjustments may be dynamic and/or configurable, for example, based on meeting the KPIs or performance targets configured by the network 105. The framework of preferable segmentation may rely on a grant prediction and traffic prediction model. The models may be used to reduce segmentation, for example, for PDCP header segmentation, for better multiplexing and padding, such as shown and discussed herein, and also with reference to FIGS. 3-4.

An artificial intelligence (AI) model may indicate thresholds for the segmentation, and such thresholds may facilitate in reducing segmentation. In some examples, a rate threshold may be used for segmentation. For example, if the UE 115 has a data rate greater than the data rate threshold, the UE 115 may delay transmission of a data unit waiting for a large enough grant. For example, if a data rate is sufficiently high and grants are regularly received, the UE 115 may avoid segmentation of a data unit and instead may use the techniques discussed herein and with reference to FIGS. 3-4 to avoid segmentation with the expectation that a sufficiently large grant will be received.

In some examples, a segmentation wait time threshold may be used for making a segmentation decision by the UE 115. For example, the threshold may indicate a maximum segmentation wait time associated with a data unit. For example, the UE 115 may delay segmentation of a data unit by waiting up to a maximum wait time. If the threshold has not elapsed since a data unit has been available for transmission, the UE 115 use the techniques discussed herein and with reference to FIGS. 3-4 to avoid segmentation while waiting for a sufficiently large grant to be received. If a data unit is waiting for an amount of time that meets or exceeds the threshold, the UE 115 may then segment and transmit the data unit in one or more packets, even if a sufficiently large grant has not yet been received.

In some examples, information elements (IEs) may be collected to support the AI and/or machine learning (ML) models, such as metadata, timestamps, etc. Such IEs may be collected to enhance an accuracy of grant predictions in terms of size and timing, rate calculations and prediction, traffic prediction, selection of a segmentation and/or multiplexing scheme as a function of a received grant, or any combination thereof.

For example, for rate calculations and prediction, the UE 115 may calculate an effective data rate, which may use a standardized formula or may rely on a UE 115 implementation if prediction is involved. For traffic prediction, if the UE 115 pads a transport block (TB) instead of segmenting a low priority data unit (e.g., low priority logical channels (LCH)), a prediction of the high data unit traffic (e.g., data units associated with a high priority LCH) may be determined since the high priority LCH may lead to continuous preemption of low priority LCH. The UE 115 may also predict which segmentation and/or multiplexing scheme to use as a function of a received grant.

In some examples, data may be collected and stored for AI/ML models used by the UE 115 for making segmentation decisions. The logged information may include a log of segmentations over time (e.g., segmentations performed as well as skipped), a log of grants received over time in bytes (e.g., to build and/or update a grant prediction model), a log of calculated or predicted data rates, a log of LCH traffic over time (e.g., to build and/or update a traffic prediction model, for example, for the low priority segmentation rule), log performance of a segmentation scheme over time in terms of latency and segmentation, etc., or any combination thereof.

In some examples, the UE 115 may transmit, to the network entity 105, a capability message to indicate one or more capabilities of the UE 115, for example, including that the UE 115 supports segmentation. In particular, the UE 115 may report a capability to perform AI-native segmentation and multiplexing along with details related to model accuracy, a quantity of LCH supported, ability to support a particular radio access technology (e.g., NR-U for prediction of channel occupancy time (COT) acquisition), or any combination thereof.

In some examples, the network entity 105 may transmit control signaling to configure the UE 115 with one or more parameters related to segmentation and multiplexing. For example, the control signaling may indicate parameters or IEs to configure the rules around segmentation and multiplexing (e.g., RLC segmentation and MAC multiplexing). The configuration may be part of an RLC configuration or LCH configuration. The parameters may include one or more of the following parameters:

TABLE 2

| Parameter | Description |
|---|---|
| MaxSkippedSize | Maximum size (in bytes) that a UE may be allowed to |
| | skip to avoid segmentation (e.g., average over time) |
| MaxSkipGrants | Maximum number of grants that a UE may be |
| | allowed to skip to avoid segmentation (e.g., average |
| | over time) |
| Max-segmentation- | Maximum time that a UE is allowed to skip before the |
| waiting-time | UE is forced to transmit even if it segmented |
| CellsEnabled | Cells where the UE is allowed to skip (e.g. behavior |
| | may be allowed in less crowded frequency 2 (FR2) |
| | but not frequency 1 (FR1) |
| AIML-Enabled | Whether the behavior is activated or deactivated |
| QoS-flow-allowed | Quality of service (QoS) flows where the behavior is |
| | allowed |
| PDCPHeaderOnly | Behavior may be limited to avoiding PDCP header |
| | segmentation only |
| RetransmissionsAllowed | Whether behavior is allowed for both transmission |
| | and retransmission or only initial transmission (RLC |
| | acknowledge mode (AM)) |
| MinRateAllowed | Minimum data rate (observed or predicted) below |
| | which segmentation is not allowed |
| AverageSkipLatency | KPI on how much latency is caused by the proposed |
| | skipping. If the latency exceeds this KPI the UE is in |
| | violation of the configuration |
| AverageSegmentation | KPI on running count of segmentation. Quantifies |
| | performance of the scheme. If UE is segmenting |
| | above this level it is in violation of KPI config. |

In some examples, the network entity 105 may transmit control signaling to configure the UE 115 with a range for a configuration, a range for a KPI configuration, or both. In an example, the network entity 105 may transmit control signaling to configure a rule for one or more behaviors, or a range for one or more behaviors, which correspond to one or more parameters of Table 2, such as a maximum skipped grant size, a maximum waiting time, minimum data rate, as well as the other parameters of Table 2, or any combination thereof. In a KPI example, a KPI may specify a set one or more performance targets for the UE. Performance targets may correspond to a segmentation metric (e.g., average quantity of segmentation within a time period), a latency metric (e.g., average latency within a time period), or the like, and may be a combination thereof. A control signaling transmitted by the network entity 105 may be used to control how the UE parametrizes a ML model to generate one or more behaviors in accordance with the configured rule or configured range for behaviors.

In some examples, the network entity 105 may transmit control signaling to configure the UE 115 with one or more KPIs that assesses the accuracy of segmentation. For example, the one or more KPIs may be a function of LCH bucket parameters, such as a prioritized bit rate, a bucket size, or other bucket-related parameters. The one or more KPIs may be a function of the configuration associated with one or more of the parameters above in Table 2. For example, if the UE 115 is exceeding a maximum segmentation waiting time and/or skipping more grants than allowed, then the UE 115 may violate one or more of the KPIs. In some examples, the UE 115 may be configured with a fallback mechanism if the UE 115 is unable to meet one or more KPIs. For example, the UE 115 may fallback to being required to comply with a legacy segmentation rule of filling a packet (e.g., 5G rules of filling the MAC PDU) using segmentation (e.g., and without including padding bits to delay data until transmission or otherwise delaying data unit transmission by avoiding segment the data unit). In some examples, the UE 115 may transmit a KPI violation report to the network entity 105, an AI/ML associated server, or both. In some examples, the network entity 105 may also monitor the UE 115 performance of segmentation (e.g., by observing padding as in FIG. 4 or padding that includes a new MAC-CE as in FIG. 5). The network entity 105 may react to the UE 115 overuse of segmentation, or overuse of skipping of segmentation, via signaling a KPI violation report to the UE 115 or instructing the UE 115 to switch off the AI segmentation procedure (e.g., as discussed herein and with reference to FIGS. 3-5). For example, the network entity 105 may transmit, to the UE 115, a control message that is a MAC-CE, or RLC control PDU, or the like, instructing the UE 115 to no longer use the AI segmentation procedure.

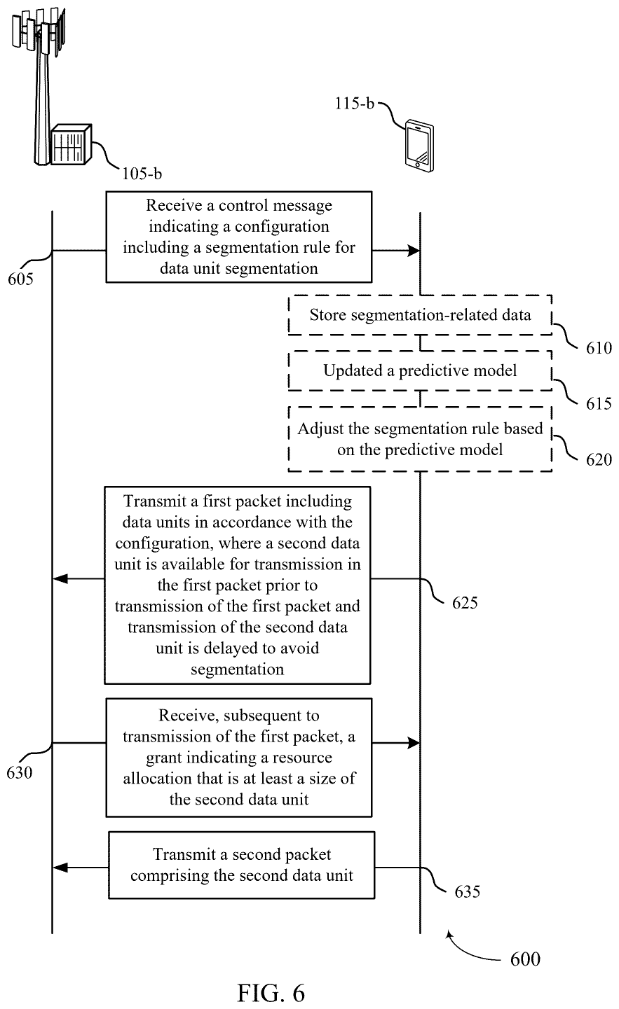

FIG. 6 shows an example of a process flow 600 that supports data unit segmentation and multiplexing in accordance with one or more aspects of the present disclosure. The process flow 600 may implement aspects of or may be implemented by aspects of the wireless communications system 100 or the wireless communications system 200. For example, the process flow 600 may include a UE 115-b and a network entity 105-b, which may be an example of a UE 115 and a network entity 105 as described herein. In the following description of the process flow 600, the operations performed by the UE 115-b and the network entity 105-b may be performed in different orders or at different times than the exemplary order shown. Some operations may also be omitted from the process flow 600, or other operations may be added to the process flow 600. Further, while operations in the process flow 600 are illustrated as being performed by the UE 115-b and the network entity 105-b, the examples herein are not to be construed as limiting, as the described features may be associated with any quantity of different devices.

At 605, the UE 115-b may receive a control message indicating a configuration including a segmentation rule for data unit segmentation. In some examples, at 610, the UE 115-b may store segmentation-related data occurring over a time period. In some examples, at 615, the UE 115-b may update a predictive model used to make decisions on whether to delay data unit transmission. In some examples, the UE 115-b may transmit, to a server or the network entity 105-b, the segmentation-related data to update a predictive model used to delay the transmission of the second data unit. The server may be, for example, an external OTT (Over the top) AI and/or machine learning (ML) model server.

In some examples, at 620, the UE 115 may adjust the segmentation rule based on a predictive model that predicts a grant, data traffic, or both, where transmission of the second data unit is delayed by the predictive model in accordance with the adjusted segmentation rule to avoid segmentation of the second data unit in the first packet. Adjustment of the rule may include enabling the UE 115 to instead include a lower priority data unit in a packet, even though a higher priority data unit is available for transmission but is too large to fit in its entirety in the packet, to avoid segmentation of the higher priority data. Adjustment of the rule may include enabling the UE 115 to instead include padding bits in a packet, even though a higher priority data unit is available for transmission but is too large to fit in its entirety in the packet, to avoid segmentation of the higher priority data. In some cases, the padding bits may include a control message, as discussed herein and with reference to FIG. 5.

At 625, the UE 115-b may transmit a first packet including one or more data units in accordance with the configuration, where a second data unit is available for transmission in the first packet prior to transmission of the first packet and transmission of the second data unit is delayed to avoid segmentation of the second data unit in the first packet. In some examples, the segmentation of the second data unit is avoided based on the UE 115-b being associated with a data rate that is greater than a data rate threshold. In some examples, segmentation of the second data unit is avoided based on a waiting time associated with the second data unit being less than a maximum waiting time threshold.

In some examples, the UE 115-b may add one or more padding bits to the first packet to fill one or more remaining bits of the first packet to avoid segmentation of the second data unit in accordance with the segmentation rule. The one or more padding bits may comprise a control message, such as a medium access control (MAC) control element (CE), uplink control information, or a radio link control message, to indicate a minimum grant size associated with the second data unit, a preferred cell to receive a grant associated with the second data unit, an expiration time associated with the second data unit, a rate threshold second data unit, or any combination thereof. In some examples, the UE 115-b may add at least one data unit to the first packet to fill one or more remaining bits of the first packet to avoid segmentation of the second data unit in accordance with the segmentation rule, where the at least one data unit has lower priority than the second data unit.

At 630, the UE 115-b may receive, subsequent to transmission of the first packet, a grant indicating a resource allocation that is at least a size of the second data unit.

At 635, the UE 115-b may transmit a second packet comprising the second data unit based at least in part on the grant.

In some examples, the UE 115-b may receive a second control message indicating an update to the segmentation rule. The second control message may indicate a key performance indicator, a fallback rule associated with the key performance indicator, a range or a rule associated with a configuration for a behavior, a range or a rule associated with at least one key performance indicator, a maximum skipped grant size, a maximum waiting time, a minimum data rate, a segmentation metric, a latency metric, or any combination thereof. In some examples, the UE 115-b may receive a third control message indicating to pause or stop segmentation based at least in part on a violation of a key performance indicator.

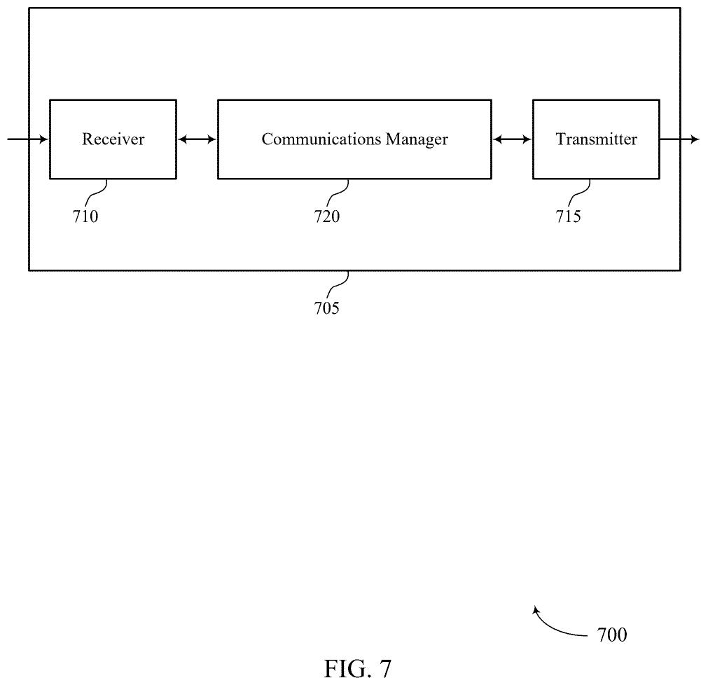

FIG. 7 shows a block diagram 700 of a device 705 that supports data unit segmentation and multiplexing in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to data unit segmentation and multiplexing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to data unit segmentation and multiplexing). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of data unit segmentation and multiplexing as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a control message indicating a configuration including a segmentation rule for data unit segmentation. The communications manager 720 is capable of, configured to, or operable to support a means for transmitting a first packet including one or more data units in accordance with the configuration, where a second data unit is available for transmission in the first packet prior to transmission of the first packet and transmission of the second data unit is delayed to avoid segmentation of the second data unit in the first packet. The communications manager 720 is capable of, configured to, or operable to support a means for receiving, subsequent to transmission of the first packet, a grant indicating a resource allocation that is at least a size of the second data unit. The communications manager 720 is capable of, configured to, or operable to support a means for transmitting a second packet including the second data unit based on the grant.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reducing segmentation of a data unit (e.g., high priority data unit) that may otherwise be segmented based on a segmentation rule, which may result in latencies or other complexities during regimentation (e.g., for a PDCP header).

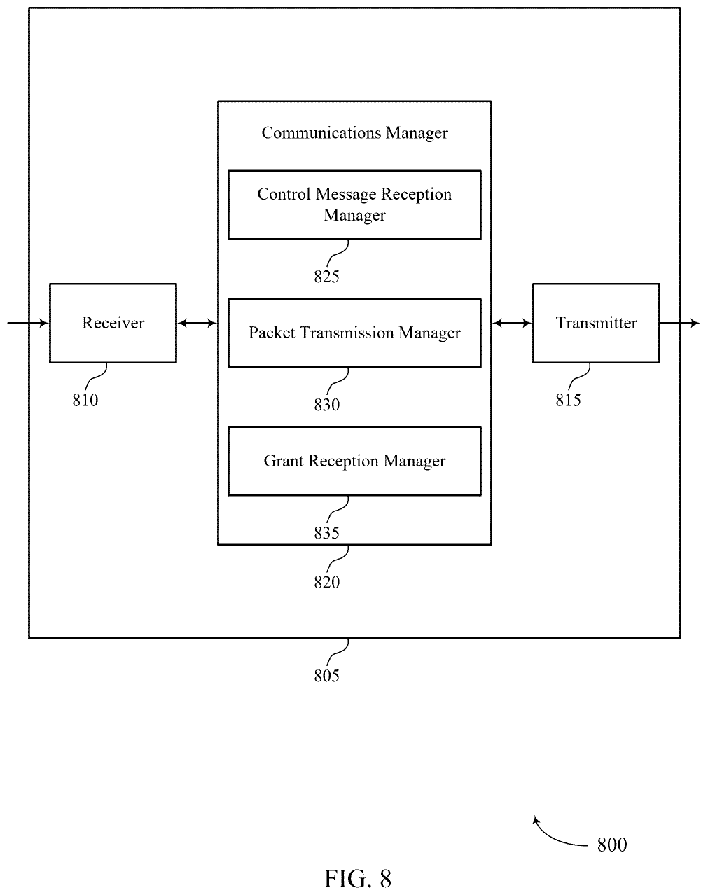

FIG. 8 shows a block diagram 800 of a device 805 that supports data unit segmentation and multiplexing in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to data unit segmentation and multiplexing). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to data unit segmentation and multiplexing). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of data unit segmentation and multiplexing as described herein. For example, the communications manager 820 may include a control message reception manager 825, a packet transmission manager 830, a grant reception manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control message reception manager 825 is capable of, configured to, or operable to support a means for receiving a control message indicating a configuration including a segmentation rule for data unit segmentation. The packet transmission manager 830 is capable of, configured to, or operable to support a means for transmitting a first packet including one or more data units in accordance with the configuration, where a second data unit is available for transmission in the first packet prior to transmission of the first packet and transmission of the second data unit is delayed to avoid segmentation of the second data unit in the first packet. The grant reception manager 835 is capable of, configured to, or operable to support a means for receiving, subsequent to transmission of the first packet, a grant indicating a resource allocation that is at least a size of the second data unit. The packet transmission manager 830 is capable of, configured to, or operable to support a means for transmitting a second packet including the second data unit based on the grant.

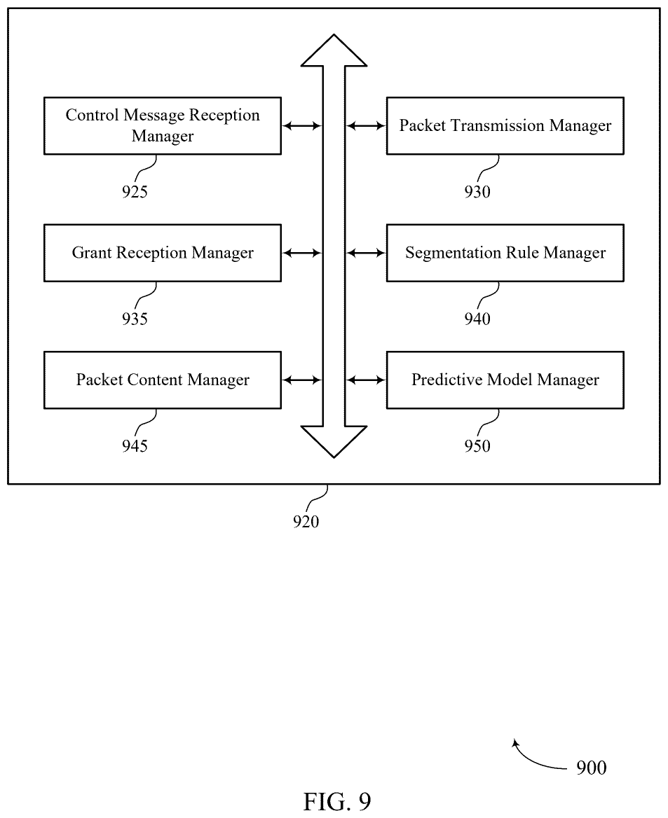

FIG. 9 shows a block diagram 900 of a communications manager 920 that supports data unit segmentation and multiplexing in accordance with one or more aspects of the present disclosure. The communications manager 920 may be an example of aspects of a communications manager 720, a communications manager 820, or both, as described herein. The communications manager 920, or various components thereof, may be an example of means for performing various aspects of data unit segmentation and multiplexing as described herein. For example, the communications manager 920 may include a control message reception manager 925, a packet transmission manager 930, a grant reception manager 935, a segmentation rule manager 940, a packet content manager 945, a predictive model manager 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The control message reception manager 925 is capable of, configured to, or operable to support a means for receiving a control message indicating a configuration including a segmentation rule for data unit segmentation. The packet transmission manager 930 is capable of, configured to, or operable to support a means for transmitting a first packet including one or more data units in accordance with the configuration, where a second data unit is available for transmission in the first packet prior to transmission of the first packet and transmission of the second data unit is delayed to avoid segmentation of the second data unit in the first packet. The grant reception manager 935 is capable of, configured to, or operable to support a means for receiving, subsequent to transmission of the first packet, a grant indicating a resource allocation that is at least a size of the second data unit. In some examples, the packet transmission manager 930 is capable of, configured to, or operable to support a means for transmitting a second packet including the second data unit based on the grant.

In some examples, the segmentation rule manager 940 is capable of, configured to, or operable to support a means for adjusting the segmentation rule based on a predictive model that predicts a grant, data traffic, or both, where transmission of the second data unit is delayed by the predictive model in accordance with the adjusted segmentation rule to avoid segmentation of the second data unit in the first packet.

In some examples, segmentation of the second data unit is avoided based on the UE being associated with a data rate that is greater than a data rate threshold.

In some examples, segmentation of the second data unit is avoided based on a waiting time associated with the second data unit being less than a maximum waiting time threshold.

In some examples, the packet content manager 945 is capable of, configured to, or operable to support a means for adding one or more padding bits to the first packet to fill one or more remaining bits of the first packet to avoid segmentation of the second data unit in accordance with the segmentation rule.

In some examples, the one or more padding bits comprises a medium access control (MAC) control element (CE), uplink control information, or a radio link control message to indicate a minimum grant size associated with the second data unit, a preferred cell to receive a grant associated with the second data unit, an expiration time associated with the second data unit, a rate threshold second data unit, or any combination thereof.

In some examples, the packet content manager 945 is capable of, configured to, or operable to support a means for adding at least one data unit to the first packet to fill one or more remaining bits of the first packet to avoid segmentation of the second data unit in accordance with the segmentation rule, where the at least one data unit has lower priority than the second data unit.

In some examples, the predictive model manager 950 is capable of, configured to, or operable to support a means for storing segmentation-related data occurring over a time period. In some examples, the predictive model manager 950 is capable of, configured to, or operable to support a means for transmitting, to a server or a network entity, the segmentation-related data to update a predictive model used to delay the transmission of the second data unit.

In some examples, the control message reception manager 925 is capable of, configured to, or operable to support a means for receiving a second control message indicating an update to the segmentation rule.

In some examples, the second control message indicates a key performance indicator, a fallback rule associated with the key performance indicator, a range or a rule associated with a configuration for a behavior, a range or a rule associated with at least one key performance indicator, a maximum skipped grant size, a maximum waiting time, a minimum data rate, a segmentation metric, a latency metric, or any combination thereof.

In some examples, the control message reception manager 925 is capable of, configured to, or operable to support a means for receiving a third control message indicating to pause or stop segmentation based on a violation of a key performance indicator.

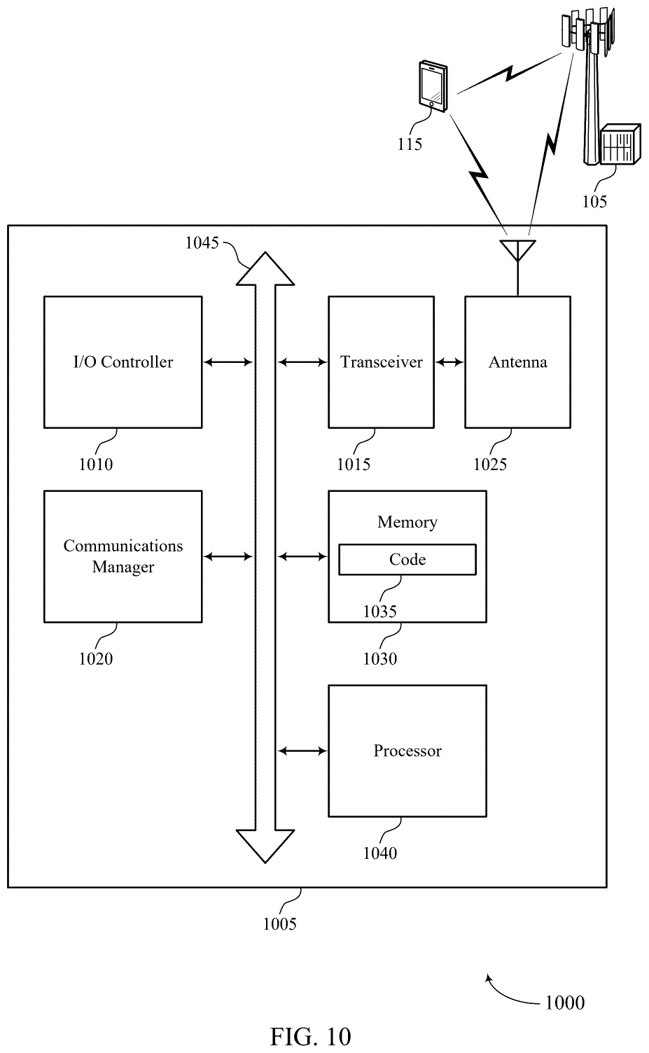

FIG. 10 shows a diagram of a system 1000 including a device 1005 that supports data unit segmentation and multiplexing in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting data unit segmentation and multiplexing). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a control message indicating a configuration including a segmentation rule for data unit segmentation. The communications manager 1020 is capable of, configured to, or operable to support a means for transmitting a first packet including one or more data units in accordance with the configuration, where a second data unit is available for transmission in the first packet prior to transmission of the first packet and transmission of the second data unit is delayed to avoid segmentation of the second data unit in the first packet. The communications manager 1020 is capable of, configured to, or operable to support a means for receiving, subsequent to transmission of the first packet, a grant indicating a resource allocation that is at least a size of the second data unit. The communications manager 1020 is capable of, configured to, or operable to support a means for transmitting a second packet including the second data unit based on the grant.

By including or configuring the communications manager 1020 in accordance with examples as described herein, the device 1005 may support techniques for reducing segmentation of a data unit (e.g., high priority data unit) that may otherwise be segmented based on a segmentation rule, which may result in latencies or other complexities during regimentation (e.g., for a PDCP header).

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of data unit segmentation and multiplexing as described herein, or the at least one processor 1040 and the at least one memory 1030 may be otherwise configured to, individually or collectively, perform or support such operations.

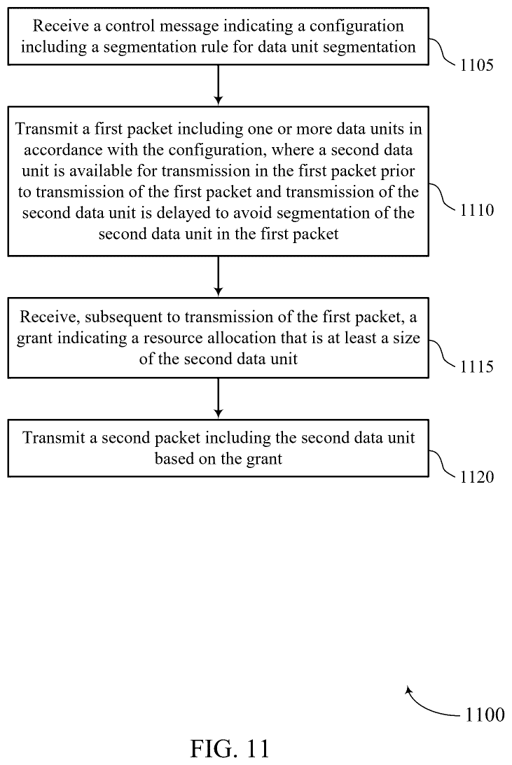

FIG. 11 shows a flowchart illustrating a method 1100 that supports data unit segmentation and multiplexing in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a control message indicating a configuration including a segmentation rule for data unit segmentation. The operations of 1105 may be performed in accordance with examples as disclosed herein. In some examples, aspects of the operations of 1105 may be performed by a control message reception manager 925 as described with reference to FIG. 9.

At 1110, the method may include transmitting a first packet including one or more data units in accordance with the configuration, where a second data unit is available for transmission in the first packet prior to transmission of the first packet and transmission of the second data unit is delayed to avoid segmentation of the second data unit in the first packet. The operations of 1110 may be performed in accordance with examples as disclosed herein. In some examples, aspects of the operations of 1110 may be performed by a packet transmission manager 930 as described with reference to FIG. 9.

At 1115, the method may include receiving, subsequent to transmission of the first packet, a grant indicating a resource allocation that is at least a size of the second data unit. The operations of 1115 may be performed in accordance with examples as disclosed herein. In some examples, aspects of the operations of 1115 may be performed by a grant reception manager 935 as described with reference to FIG. 9.

At 1120, the method may include transmitting a second packet including the second data unit based on the grant. The operations of 1120 may be performed in accordance with examples as disclosed herein. In some examples, aspects of the operations of 1120 may be performed by a packet transmission manager 930 as described with reference to FIG. 9.

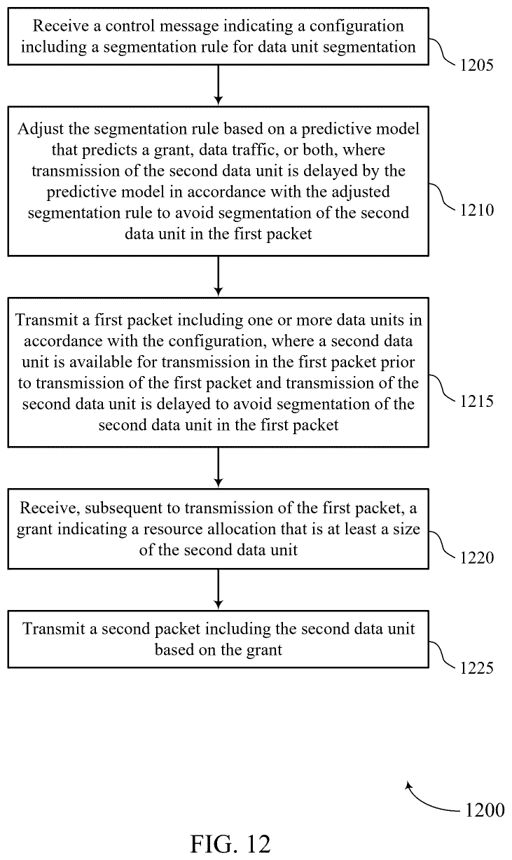

FIG. 12 shows a flowchart illustrating a method 1200 that supports data unit segmentation and multiplexing in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving a control message indicating a configuration including a segmentation rule for data unit segmentation. The operations of 1205 may be performed in accordance with examples as disclosed herein. In some examples, aspects of the operations of 1205 may be performed by a control message reception manager 925 as described with reference to FIG. 9.

At 1210, the method may include adjusting the segmentation rule based on a predictive model that predicts a grant, data traffic, or both, where transmission of the second data unit is delayed by the predictive model in accordance with the adjusted segmentation rule to avoid segmentation of the second data unit in the first packet. The operations of 1210 may be performed in accordance with examples as disclosed herein. In some examples, aspects of the operations of 1210 may be performed by a segmentation rule manager 940 as described with reference to FIG. 9.

At 1215, the method may include transmitting a first packet including one or more data units in accordance with the configuration, where a second data unit is available for transmission in the first packet prior to transmission of the first packet and transmission of the second data unit is delayed to avoid segmentation of the second data unit in the first packet. The operations of 1215 may be performed in accordance with examples as disclosed herein. In some examples, aspects of the operations of 1215 may be performed by a packet transmission manager 930 as described with reference to FIG. 9.

At 1220, the method may include receiving, subsequent to transmission of the first packet, a grant indicating a resource allocation that is at least a size of the second data unit. The operations of 1220 may be performed in accordance with examples as disclosed herein. In some examples, aspects of the operations of 1220 may be performed by a grant reception manager 935 as described with reference to FIG. 9.

At 1225, the method may include transmitting a second packet including the second data unit based on the grant. The operations of 1225 may be performed in accordance with examples as disclosed herein. In some examples, aspects of the operations of 1225 may be performed by a packet transmission manager 930 as described with reference to FIG. 9.

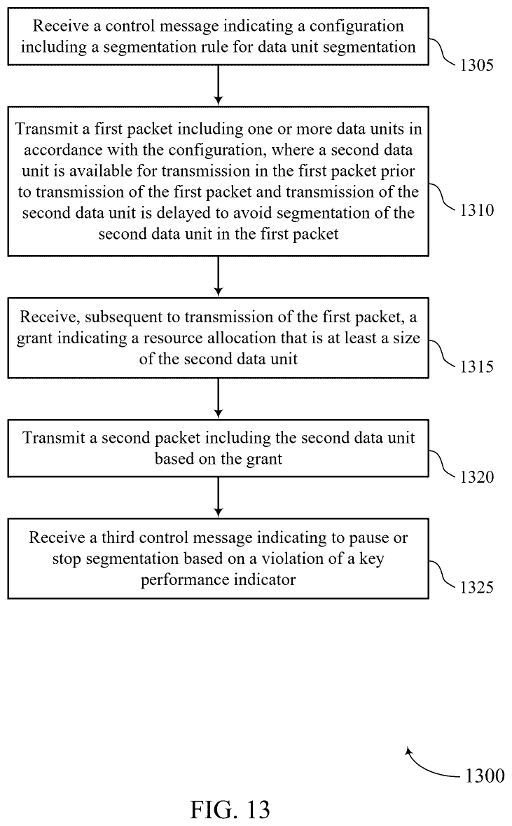

FIG. 13 shows a flowchart illustrating a method 1300 that supports data unit segmentation and multiplexing in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating a configuration including a segmentation rule for data unit segmentation. The operations of 1305 may be performed in accordance with examples as disclosed herein. In some examples, aspects of the operations of 1305 may be performed by a control message reception manager 925 as described with reference to FIG. 9.

At 1310, the method may include transmitting a first packet including one or more data units in accordance with the configuration, where a second data unit is available for transmission in the first packet prior to transmission of the first packet and transmission of the second data unit is delayed to avoid segmentation of the second data unit in the first packet. The operations of 1310 may be performed in accordance with examples as disclosed herein. In some examples, aspects of the operations of 1310 may be performed by a packet transmission manager 930 as described with reference to FIG. 9.

At 1315, the method may include receiving, subsequent to transmission of the first packet, a grant indicating a resource allocation that is at least a size of the second data unit. The operations of 1315 may be performed in accordance with examples as disclosed herein. In some examples, aspects of the operations of 1315 may be performed by a grant reception manager 935 as described with reference to FIG. 9.

At 1320, the method may include transmitting a second packet including the second data unit based on the grant. The operations of 1320 may be performed in accordance with examples as disclosed herein. In some examples, aspects of the operations of 1320 may be performed by a packet transmission manager 930 as described with reference to FIG. 9.

At 1325, the method may include receiving a third control message indicating to pause or stop segmentation based on a violation of a key performance indicator. The operations of 1325 may be performed in accordance with examples as disclosed herein. In some examples, aspects of the operations of 1325 may be performed by a control message reception manager 925 as described with reference to FIG. 9.

The following provides an overview of aspects of the present disclosure:
Aspect 1: A method for wireless communications at a UE, comprising: receiving a control message indicating a configuration comprising a segmentation rule for data unit segmentation; transmitting a first packet comprising one or more data units in accordance with the configuration, wherein a second data unit is available for transmission in the first packet prior to transmission of the first packet and transmission of the second data unit is delayed to avoid segmentation of the second data unit in the first packet; receiving, subsequent to transmission of the first packet, a grant indicating a resource allocation that is at least a size of the second data unit; and transmitting a second packet comprising the second data unit based at least in part on the grant.
Aspect 2: The method of aspect 1, further comprising: adjusting the segmentation rule based at least in part on a predictive model that predicts a grant, data traffic, or both, wherein transmission of the second data unit is delayed by the predictive model in accordance with the adjusted segmentation rule to avoid segmentation of the second data unit in the first packet.
Aspect 3: The method of any of aspects 1 through 2, wherein segmentation of the second data unit is avoided based at least in part on the UE being associated with a data rate that is greater than a data rate threshold.
Aspect 4: The method of any of aspects 1 through 3, wherein segmentation of the second data unit is avoided based at least in part on a waiting time associated with the second data unit being less than a maximum waiting time threshold.
Aspect 5: The method of any of aspects 1 through 4, further comprising: adding one or more padding bits to the first packet to fill one or more remaining bits of the first packet to avoid segmentation of the second data unit in accordance with the segmentation rule.
Aspect 6: The method of aspect 5, wherein the one or more padding bits comprises a medium access control (MAC) control element (CE), uplink control information, or a radio link control message to indicate a minimum grant size associated with the second data unit, a preferred cell to receive a grant associated with the second data unit, an expiration time associated with the second data unit, a rate threshold second data unit, or any combination thereof.
Aspect 7: The method of any of aspects 1 through 6, further comprising: adding at least one data unit to the first packet to fill one or more remaining bits of the first packet to avoid segmentation of the second data unit in accordance with the segmentation rule, wherein the at least one data unit has lower priority than the second data unit.
Aspect 8: The method of any of aspects 1 through 7, further comprising: storing segmentation-related data occurring over a time period; and transmit, to a server or a network entity, the segmentation-related data to update a predictive model used to delay the transmission of the second data unit.
Aspect 9: The method of any of aspects 1 through 8, further comprising: receiving a second control message indicating an update to the segmentation rule.
Aspect 10: The method of aspect 9, wherein the second control message indicates a key performance indicator, a fallback rule associated with the key performance indicator, a range or a rule associated with a configuration for a behavior, a range or a rule associated with at least one key performance indicator, a maximum skipped grant size, a maximum waiting time, a minimum data rate, a segmentation metric, a latency metric, or any combination thereof.
Aspect 11: The method of any of aspects #through #, further comprising: receiving a third control message indicating to pause or stop segmentation based at least in part on a violation of a key performance indicator.
Aspect 12: A UE for wireless communications, comprising one or more memories storing processor-executable code, and one or more processors coupled with the one or more memories and individually or collectively operable to execute the code to cause the UE to perform a method of any of aspects 1 through 11.
Aspect 13: A UE for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating a configuration comprising a segmentation rule for data unit segmentation;
transmit a first packet comprising one or more data units in accordance with the configuration, wherein a second data unit is available for transmission in the first packet prior to transmission of the first packet and transmission of the second data unit is delayed to avoid segmentation of the second data unit in the first packet;
receive, subsequent to transmission of the first packet, a grant indicating a resource allocation that is at least a size of the second data unit; and
transmit a second packet comprising the second data unit based at least in part on the grant.

2. The UE of claim 1, wherein the one or more processors are individually or collectively further operable to execute the code to cause the UE to:
adjust the segmentation rule based at least in part on a predictive model that predicts a grant, data traffic, or both, wherein transmission of the second data unit is delayed by the predictive model in accordance with the adjusted segmentation rule to avoid segmentation of the second data unit in the first packet.

3. The UE of claim 1, wherein segmentation of the second data unit is avoided based at least in part on the UE being associated with a data rate that is greater than a data rate threshold.

4. The UE of claim 1, wherein segmentation of the second data unit is avoided based at least in part on a waiting time associated with the second data unit being less than a maximum waiting time threshold.

5. The UE of claim 1, wherein the one or more processors are individually or collectively further operable to execute the code to cause the UE to:
add one or more padding bits to the first packet to fill one or more remaining bits of the first packet to avoid segmentation of the second data unit in accordance with the segmentation rule.

6. The UE of claim 5, wherein the one or more padding bits comprises a medium access control (MAC) control element (CE), uplink control information, or a radio link control message to indicate a minimum grant size associated with the second data unit, a preferred cell to receive a grant associated with the second data unit, an expiration time associated with the second data unit, a rate threshold second data unit, or any combination thereof.

7. The UE of claim 1, wherein the one or more processors are individually or collectively further operable to execute the code to cause the UE to:
add at least one data unit to the first packet to fill one or more remaining bits of the first packet to avoid segmentation of the second data unit in accordance with the segmentation rule, wherein the at least one data unit has lower priority than the second data unit.

8. The UE of claim 1, wherein the one or more processors are individually or collectively further operable to execute the code to cause the UE to:
store segmentation-related data occurring over a time period; and
transmit, to a server or a network entity, the segmentation-related data to update a predictive model used to delay the transmission of the second data unit.

9. The UE of claim 1, wherein the one or more processors are individually or collectively further operable to execute the code to cause the UE to:
receive a second control message indicating an update to the segmentation rule.

10. The UE of claim 9, wherein the second control message indicates a key performance indicator, a fallback rule associated with the key performance indicator, a range or a rule associated with a configuration for a behavior, a range or a rule associated with at least one key performance indicator, a maximum skipped grant size, a maximum waiting time, a minimum data rate, a segmentation metric, a latency metric, or any combination thereof.

11. The UE of claim 1, wherein the one or more processors are individually or collectively further operable to execute the code to cause the UE to:
receive a third control message indicating to pause or stop segmentation based at least in part on a violation of a key performance indicator.

12. A method for wireless communications at a user equipment (UE), comprising:
receiving a control message indicating a configuration comprising a segmentation rule for data unit segmentation;
transmitting a first packet comprising one or more data units in accordance with the configuration, wherein a second data unit is available for transmission in the first packet prior to transmission of the first packet and transmission of the second data unit is delayed to avoid segmentation of the second data unit in the first packet;
receiving, subsequent to transmission of the first packet, a grant indicating a resource allocation that is at least a size of the second data unit; and
transmitting a second packet comprising the second data unit based at least in part on the grant.

13. The method of claim 12, further comprising:
adjusting the segmentation rule based at least in part on a predictive model that predicts a grant, data traffic, or both, wherein transmission of the second data unit is delayed by the predictive model in accordance with the adjusted segmentation rule to avoid segmentation of the second data unit in the first packet.

14. The method of claim 12, wherein segmentation of the second data unit is avoided based at least in part on the UE being associated with a data rate that is greater than a data rate threshold.

15. The method of claim 12, wherein segmentation of the second data unit is avoided based at least in part on a waiting time associated with the second data unit being less than a maximum waiting time threshold.

16. The method of claim 12, further comprising:
adding one or more padding bits to the first packet to fill one or more remaining bits of the first packet to avoid segmentation of the second data unit in accordance with the segmentation rule.

17. The method of claim 16, wherein the one or more padding bits comprises a medium access control (MAC) control element (CE), uplink control information, or a radio link control message to indicate a minimum grant size associated with the second data unit, a preferred cell to receive a grant associated with the second data unit, an expiration time associated with the second data unit, a rate threshold second data unit, or any combination thereof.

18. A non-transitory computer-readable medium storing code for wireless communications, the code comprising instructions executable by one or more processors to:
receive a control message indicating a configuration comprising a segmentation rule for data unit segmentation;
transmit a first packet comprising one or more data units in accordance with the configuration, wherein a second data unit is available for transmission in the first packet prior to transmission of the first packet and transmission of the second data unit is delayed to avoid segmentation of the second data unit in the first packet;
receive, subsequent to transmission of the first packet, a grant indicating a resource allocation that is at least a size of the second data unit; and
transmit a second packet comprising the second data unit based at least in part on the grant.

19. The non-transitory computer-readable medium of claim 18, wherein the instructions are further executable by the one or more processors to:
receive a second control message indicating an update to the segmentation rule.

20. The non-transitory computer-readable medium of claim 18, wherein the instructions are further executable by the one or more processors to:
receive a third control message indicating to pause or stop segmentation based at least in part on a violation of a key performance indicator.
